(19) United States
(12) Patent Application Publication
(10) Pub. No.: US 2025/0301216 A1
(43) Pub. Date: Sep. 25, 2025

(54) MULTI-DEVICE PHOTOGRAPHING CONTROL METHOD AND VR HEAD-MOUNTED DISPLAY DEVICE

(71) Applicant: Beijing Zitiao Network Technology Co., Ltd., Beijing (CN)

(72) Inventors: Jiu XIA, Beijing (CN); Guanghui LIU, Beijing (CN)

(21) Appl. No.: 18/853,283

(22) PCT Filed: Mar. 31, 2023
(86) PCT No.: PCT/CN2023/085637

§ 371 Date: Jun. 9, 2025

(30) Foreign Application Priority Data
Apr. 1, 2022 (CN) 202210349279.9

(51) Int. Cl. H04N 23/66; G06F 3/01; H04N 23/73

(52) U.S. Cl. CPC H04N 23/66; H04N 23/73; G06F 3/017

(57) ABSTRACT

The present disclosure relates to a multi-device photographing control method and a virtual reality (VR) head-mounted display device, and relates to the technical field of virtual devices. The method is applied to a first VR head-mounted display device, and the first VR head-mounted display device is configured to establish a communication connection with at least one second VR head-mounted display device. The method comprises: determining a photographing moment of the first VR head-mounted display device; determining exposure indication information according to the photographing moment of the first VR head-mounted display device; and sending the exposure indication information to the at least one second VR head-mounted display device. The embodiments of the present disclosure are used for solving the problem of image overexposure caused by simultaneous exposure by a plurality of VR head-mounted display devices.

### CROSS-REFERENCE TO RELATED APPLICATION(S)

This application claims priority to Chinese Patent Application No. 202210349279.9, entitled “MULTI-DEVICE PHOTOGRAPHING CONTROL METHOD AND VR HEAD-MOUNTED DISPLAY DEVICE” filed on Apr. 1, 2022, which is incorporated herein by reference in its entirety.

### FIELD

The present disclosure relates to the technical field of virtual devices, and in particular, to a multi-device photographing control method and a virtual reality (VR) head-mounted display device.

### BACKGROUND

With the improvement of network speed, an Internet era based on a virtual reality technology emerges, which will greatly change the way of production and the lifestyle. At present, when a user uses a virtual reality device, a gesture of the user needs to be recognized, and during recognition, an infrared lamp is mainly used to fill light to facilitate the virtual reality device to photograph clear images. However, when many users use virtual reality devices for game entertainment, using a plurality of infrared lamps to simultaneously fill light would cause overexposure of photographed images. This has a negative impact on the recognition of the gestures of the users by the virtual reality devices based on the images.

### SUMMARY

To solve the above technical problems or to at least partially solve the above technical problems, the present disclosure provides a multi-device photographing control method and a VR head-mounted display device, which can solve the problem of image overexposure caused by simultaneous light filled by a plurality of virtual reality devices.

In order to achieve the above objectives, embodiments of the present disclosure provide the following technical solutions.

In a first aspect, the present disclosure provides a multi-device photographing control method, applied to a first VR head-mounted display device, wherein the first VR head-mounted display device is configured to establish a communication connection with at least one second VR head-mounted device, and the method comprises:
determining a photographing moment of the first VR head-mounted display device:
determining exposure indication information according to the photographing moment of the first VR head-mounted display device; and
sending the exposure indication information to the at least one second VR head-mounted display device,
wherein the exposure indication information is used for determining a photographing moment of the at least one second VR head-mounted display device.

As an optional implementation of the embodiments of the present disclosure, the exposure indication information comprises: the photographing moment or a delayed photographing time of the at least one second VR head-mounted display device.

As an optional implementation of the embodiments of the present disclosure, determining exposure indication information according to the photographing moment of the first VR head-mounted display device comprises: determining photographing sequence information of the at least one second VR head-mounted display device; and determining a photographing moment or a delayed photographing time of the at least one second VR head-mounted display device according to the photographing moment of the first VR head-mounted display device and the photographing sequence information of the at least one second VR head-mounted display device.

As an optional implementation of the embodiments of the present disclosure, a time interval between the photographing moments of various second VR head-mounted display devices among the at least one second VR head-mounted display device is greater than or equal to preset exposure time, and a time difference between delayed photographing times of the various second VR head-mounted display devices is greater than or equal to the preset exposure time.

As an optional implementation of the embodiments of the present disclosure, determining photographing sequence information of the at least one second VR head-mounted display device comprises: determining the photographing sequence information of the at least one second VR head-mounted display device according to a sequence in which the at least one second VR head-mounted display device establishes the communication connection with the first VR head-mounted display device.

As an optional implementation of the embodiments of the present disclosure, the method further comprises: when the first VR head-mounted display device establishes the communication connection with the at least one second VR head-mounted display device, sending photographing sequence information to the at least one second VR head-mounted display device, wherein the photographing sequence information corresponding to the at least one second VR head-mounted display device corresponds to a connection sequence, and the connection sequence is a sequence in which the at least one second VR head-mounted display device establishes the communication connection with the first VR head-mounted display device.

As an optional implementation of the embodiments of the present disclosure, the exposure indication information is the photographing moment of the first VR head-mounted display device.

As an optional implementation of the embodiments of the present disclosure, the exposure indication information comprises: device identifiers of various second VR head-mounted display devices among the at least one second VR head-mounted display device, and a photographing moment or a delayed photographing time corresponding to each of the device identifiers.

As an optional implementation of the embodiments of the present disclosure, the sending the exposure indication information to the at least one second VR head-mounted display device comprises: sending the exposure indication information to the at least one second VR head-mounted display device by broadcasting: or, sending the exposure indication information to the at least one second VR head-mounted display device, respectively.

In a second aspect, the present disclosure provides a multi-device photographing control method, applied to a second VR head-mounted display device, wherein the second VR head-mounted display device is configured to establish a communication connection with a first VR head-mounted device, and the method comprises:
receiving exposure indication information sent by the first VR head-mounted display device,
wherein the exposure indication information is used for determining a photographing moment of the second VR head-mounted display device.

As an optional implementation of the embodiments of the present disclosure, the exposure indication information comprises a photographing moment or a delayed photographing time of the second VR head-mounted display device.

As an optional implementation of the embodiments of the present disclosure, the method further comprises: when establishing the communication connection with the first VR head-mounted display device, receiving the photographing sequence information of the second VR head-mounted display device sent by the first VR head-mounted display device:
receiving exposure indication information sent by the first VR head-mounted display device comprises: receiving a photographing moment of the first VR head-mounted display device broadcast by the first VR head-mounted display device; and
the method further comprises: determining the photographing moment of the second VR head-mounted display device according to the photographing moment of the first VR head-mounted display device and the photographing sequence information of the second VR head-mounted display device.

As an optional implementation of the embodiments of the present disclosure, the exposure indication information comprises: a device identifier of at least one second VR head-mounted display device, and a photographing moment or a delayed photographing time corresponding to each of the device identifiers; and
receiving exposure indication information sent by the first VR head-mounted display device comprises: receiving at least one device identifier broadcast by the first VR head-mounted display device, and the photographing moment or a delayed photographing time corresponding to each of the device identifiers; determining a target device identifier corresponding to the second VR head-mounted display device; and determining the photographing moment or the delayed photographing time corresponding to the target device identifier as the photographing moment or the delayed photographing time of the second VR head-mounted display device.

In a third aspect, the present disclosure provides a first VR head-mounted display device, wherein the first VR head-mounted display device is configured to establish a communication connection with at least one second VR head-mounted device. The VR head-mounted display device comprises:
a processing module, configured to: determine a photographing moment of the first VR head-mounted display device, and determine exposure indication information according to the photographing moment of the first VR head-mounted display device; and
a sending module, configured to send the exposure indication information to the at least one second VR head-mounted display device,
wherein the exposure indication information is used for determining a photographing moment of the at least one second VR head-mounted display device.

As an optional implementation of the embodiments of the present disclosure, the exposure indication information comprises: the photographing moment or a delayed photographing time of the at least one second VR head-mounted display device; and
the sending module is specifically configured to respectively send photographing moments or delayed photographing times of various second VR head-mounted display devices to the at least one second VR head-mounted display device;
a time interval between the photographing moments of the various second VR head-mounted display devices is greater than or equal to preset exposure time, and a time interval between the delayed photographing times of the various second VR head-mounted display devices is greater than or equal to the preset exposure time.

As an optional implementation of the embodiments of the present disclosure, the processing module is specifically configured to: determine photographing sequence information of the at least one second VR head-mounted display device; and
determine the photographing moment of at least one second VR head-mounted display device according to the photographing moment of the first VR head-mounted display device and the photographing sequence information of the at least one second VR head-mounted display device.

As an optional implementation of the embodiments of the present disclosure, the processing module is specifically configured to determine the photographing sequence information of the at least one second VR head-mounted display device according to a sequence in which the at least one second VR head-mounted display device establishes the communication connection with the first VR head-mounted display device.

As an optional implementation of the embodiments of the present disclosure, the processing module is further configured to: when the first VR head-mounted display device establishes the communication connection with the at least one second VR head-mounted display device, send photographing sequence information to the at least one second VR head-mounted display device, wherein the photographing sequence information corresponding to the at least one second VR head-mounted display device corresponds to a connection sequence, and the connection sequence is a sequence in which the at least one second VR head-mounted display device establishes the communication connection with the first VR head-mounted display device.

As an optional implementation of the embodiments of the present disclosure, the exposure indication information is the photographing moment of the first VR head-mounted display device.

As an optional implementation of the embodiments of the present disclosure, the exposure indication information comprises: device identifiers of various second VR head-mounted display devices among the at least one second VR head-mounted display device, and a photographing moment or a delayed photographing time corresponding to each of the device identifiers.

As an optional implementation of the embodiments of the present disclosure, the sending module is specifically configured to: send the exposure indication information to the at least one second VR head-mounted display device by broadcasting: or, respectively send the exposure indication information to the at least one second VR head-mounted display device.

In a fourth aspect, the present disclosure provides a second VR head-mounted display device, wherein the second VR head-mounted display device is configured to establish a communication connection with a first VR head-mounted device. The VR head-mounted display device comprises:
a receiving module, configured to receive exposure indication information sent by the first VR head-mounted display device,
wherein the exposure indication information is used for determining a photographing moment of the second VR head-mounted display device.

As an optional implementation of the embodiments of the present disclosure, the exposure indication information comprises a photographing moment or a delayed photographing time of the second VR head-mounted display device.

As an optional implementation of the embodiments of the present disclosure, the receiving module is specifically configured to: receive a photographing moment of the first VR head-mounted display device broadcast by the first VR head-mounted display device; and determine the photographing moment of the second VR head-mounted display device according to the photographing moment of the first VR head-mounted display device and the photographing sequence information of the second VR head-mounted display device.

As an optional implementation of the embodiments of the present disclosure, the exposure indication information comprises: a device identifier of at least one second VR head-mounted display device, and a photographing moment or a delayed photographing time corresponding to each of the device identifiers; and the receiving module is specifically configured to: receive at least one device identifier broadcast by the first VR head-mounted display device, and the photographing moment or a delayed photographing time corresponding to each of the device identifiers;
determine a target device identifier corresponding to the second VR head-mounted display device; and
determine the photographing moment or the delayed photographing time corresponding to the target device identifier as the photographing moment or the delayed photographing time of the second VR head-mounted display device.

In a fifth aspect, a first VR head-mounted display device is provided, including: a processor, a memory, and a computer program stored on the memory and executable on the processor, wherein the computer program, when run by the processor, implements the multi-device photographing control method as described in the first aspect or any optional implementation of the first aspect.

In a sixth aspect, a second VR head-mounted display device is provided. A first VR head-mounted display device is configured to establish a communication connection with at least one second VR head-mounted display device, and a camera and an infrared light filling lamp are arranged on a surface of a shell of each VR head-mounted display device. The second VR head-mounted display device comprises: a processor, a memory, and a computer program stored on the memory and executable on the processor, wherein the computer program, when run by the processor, implements the multi-device photographing control method as described in the second aspect or any optional implementation of the second aspect.

In a seventh aspect, a computer-readable storage medium, with a computer program stored thereon, wherein the computer program, when run by a processor, implements, a memory, and a computer program stored on the memory and executable on the processor, wherein the computer program, when run by the processor, implements the multi-device photographing control method as described in the first aspect or any optional implementation of the first aspect, or the multi-device photographing control method as described in the second aspect or any optional implementation of the second aspect.

In an eighth aspect, a computer program product is provided, including a computer program, wherein the computer program, when run on a computer, causes the computer to implement the multi-device photographing control method as described in the first aspect or any optional implementation of the first aspect, or the multi-device photographing control method as described in the second aspect or any optional implementation of the second aspect.

Compared with the related art, the technical solutions provided by the embodiments of the present disclosure have the following advantages.

A multi-device photographing control method provided by embodiments of the present disclosure is applied to a first VR head-mounted display device. The first VR head-mounted display device is configured to establish a communication connection with at least one second VR head-mounted device. In the method, the photographing moment of the first VR head-mounted display device is determined first. The photographing moment of the first VR head-mounted display device is both an exposure start moment of a camera of the first VR head-mounted display device and a fill light start moment of an infrared light filling lamp of the first VR head-mounted display device. Exposure indication information is determined according to the photographing moment of the first VR head-mounted display device, and the exposure indication information is sent to at least one second VR head-mounted display device to instruct the at least one second VR head-mounted display device to determine photographing moments of various second VR head-mounted display devices. As such, the first VR head-mounted display device controls the exposure moment of at least one VR head-mounted display device to achieve light filling and exposure for a plurality of VR head-mounted display devices at different moments in the same scene and prevent overexposure of an image photographed by each VR head-mounted display device.

### BRIEF DESCRIPTION OF THE DRAWINGS

The drawings here are incorporated into and form part of the specification, showing the embodiments that comply with the present disclosure, and are used together with the specification to explain the principles of the present disclosure.

In order to describe the technical solutions in the embodiments of the present disclosure or in the related art more clearly, the following briefly introduces the accompanying drawings for describing the embodiments or the related art. Apparently, a person of ordinary skill in the art may still derive other drawings from the accompanying drawings without creative effort.

FIG. 1A is a schematic diagram I of an application scene of a multi-device photographing control method according to embodiments of the present disclosure:

FIG. 1B is a schematic diagram II of an application scene of a multi-device photographing control method according to embodiments of the present disclosure;

FIG. 2 is a flowchart of a multi-device photographing control method according to embodiments of the present disclosure:

FIG. 3 is a schematic diagram of a time axis of a photographing moment;

FIG. 4 is a schematic diagram of photographing moments of a first VR head-mounted display device and at least one second VR head-mounted display device:

FIG. 5 is a structural diagram I of the first VR head-mounted display device according to embodiments of the present disclosure;

FIG. 6 is a structural diagram I of the second VR head-mounted display device according to embodiments of the present disclosure:

FIG. 7 is a structural diagram II of the first VR head-mounted display device according to embodiments of the present disclosure; and

FIG. 8 is a structural diagram II of the second VR head-mounted display device according to embodiments of the present disclosure.

### DETAILED DESCRIPTION OF EMBODIMENTS

In order to better understand the above objectives, features, and advantages of the present disclosure, the following will further describe the solutions of the present disclosure. It should be noted that the embodiments of the present disclosure and features in the embodiments may be mutually combined without conflicts.

Many specific details have been elaborated in the following description to facilitate a full understanding of the present disclosure, but the present disclosure can also be implemented in other ways different from those described here. Obviously, the embodiments in the specification are only part of the embodiments of the present disclosure, rather than all the embodiments.

A virtual Reality (VR) head-mounted display is a virtual reality head-mounted display device that uses a head-mounted display device to: close off the visual and auditory perception of a user to the outside world and create a feeling for the user of being in a virtual environment. Its display principle is that screens for the left and right eye respectively display images of the left and right eyes, and a sense of three dimension is generated in the mind after obtaining the information with differences. The devices comprise, but are not limited to, a pair of VR glasses and a VR helmet.

Gesture recognition is crucial in the field of virtual reality, and especially has an important role in light interaction in the experience of a virtual reality scene. Therefore, gesture recognition has high requirements for the precision of bare hand tracking, delay, and the environmental compatibility and stability. In gesture recognition in the field of virtual reality, an environment capturing camera that is arranged on a virtual reality device tracks and recognizes hand information of a user.

At present, when a user uses a virtual reality device, a gesture of the user needs to be recognized, and during recognition, an infrared lamp is mainly used to fill light to facilitate the virtual reality device to photograph clear images. However, when many users use virtual reality devices for game entertainment, using a plurality of infrared lamps to simultaneously fill light would cause overexposure of photographed images. This has a negative impact on the recognition of the gestures of the users by the virtual reality devices based on the images.

To solve the above problems, the embodiments of the present disclosure provide a multi-device photographing control method and VR head-mounted display devices. The multi-device photographing control method may be applied to a first VR head-mounted display device, and the first VR head-mounted display device is configured to establish a communication connection with at least one second VR head-mounted device. In this method, a photographing moment of the first VR head-mounted display device is determined first. The photographing moment of the first VR head-mounted display device is both an exposure start moment of a camera of the first VR head-mounted display device and a fill light start moment of an infrared light filling lamp of the first VR head-mounted display device. Exposure indication information is determined according to the photographing moment of the first VR head-mounted display device, and the exposure indication information is sent to at least one second VR head-mounted display device to instruct the at least one second VR head-mounted display device to determine photographing moments of various second VR head-mounted display devices. As such, the first VR head-mounted display device controls the exposure moment of at least one VR head-mounted display device to achieve light filling and exposure for a plurality of VR head-mounted display devices at different moments in the same scene and prevent overexposure of an image photographed by each VR head-mounted display device. This benefits for recognizing a gesture of a user by a virtual reality device based on images.

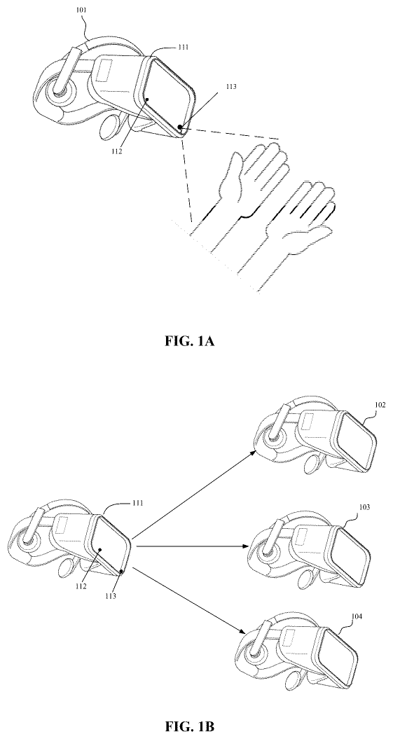

FIG. 1A is a schematic diagram I of an application scene of a multi-device photographing control method according to an embodiment of the present disclosure. In this figure, a camera 112 and an infrared light filling lamp 113 are arranged on a surface 111 of a shell of a first VR head-mounted display device 101. When the first VR head-mounted display device 101 performs gesture recognition, the infrared light filling lamp 113 needs to be turned on to fill light.

FIG. 1B is a schematic diagram II of an application scene of a multi-device photographing control method according to an embodiment of the present disclosure. In FIG. 1B, there is a first VR head-mounted display device 101, a second VR head-mounted display device 102, a second VR head-mounted display device 103, and a second VR head-mounted display device 104. A camera 112 and an infrared light filling lamp 113 are arranged on a surface 111 of a shell of the first VR head-mounted display device 101. It should be noted that cameras and infrared light filling lamps are arranged on surfaces of shells of the second VR head-mounted display device 102, the second VR head-mounted display device 103, and the second VR head-mounted display device 104, but they are not fully shown in FIG. 1B. It should be noted that positions and roles of the first VR head-mounted display device and each second VR head-mounted display device can be interchanged.

As shown in FIG. 1B, the first VR head-mounted display device 101 determines its photographing moment, then determines exposure indication information according to the photographing moment, and further sends the exposure indication information to the second VR head-mounted display device 102, the second VR head-mounted display device 103, and the second VR head-mounted display device 104, thereby instructing the second VR head-mounted display device 102, the second VR head-mounted display device 103, and the second VR head-mounted display device 104 each to determine respective photographing moments. Thus each VR head-mounted display device performs exposure and light filling at different moments, thereby avoiding image overexposure caused by the plurality of VR head-mounted display devices filling light for photographing at the same moment, and improving the quality of images. This further facilitates each VR head-mounted display device to perform the gesture recognition based on images.

In some embodiments, as shown in FIG. 1B, the first VR head-mounted display device 101 determines photographing sequence information of the second VR head-mounted display device 102, the second VR head-mounted display device 103, and the second VR head-mounted display device 104 as follows: 102, 103, and 104. Then, in combination with its own photographing moment to, the first VR head-mounted display device determines a photographing moment of the second VR head-mounted display device 102 as t1, a photographing moment of the second VR head-mounted display device 103 as t2, and a photographing moment of the second VR head-mounted display device 104 as t3.

In addition, a delayed photographing time of the second VR head-mounted display device 102 may be determined as ΔT; a delayed photographing time of the second VR head-mounted display device 103 is determined as 2ΔT, and a delayed photographing time of the second VR head-mounted display device 104 is determined as 3ΔT, thereby instructing the second VR head-mounted display device 102 to start photographing from, after waiting for the delayed photographing time ΔT, photographing moment to of the first VR head-mounted display device 101, or a moment at which the exposure indication information is received, or a moment preset as an agreed moment through the communication connection. Starting photographing from photographing moment t of the first VR head-mounted display device 101 is taken as an example. The second VR head-mounted display device 103 starts photographing after waiting for delayed photographing moment 2ΔT from the photographing moment t0. The second VR head-mounted display device 104 starts photographing after waiting for delayed photographing moment 3ΔT from the photographing moment t0. Each VR head-mounted display device performs exposure and light filling at different moments, thereby avoiding image overexposure caused by the plurality of VR head-mounted display devices filling light for photographing at the same moment, and improving the quality of images. This further facilitates each VR head-mounted display device to perform the gesture recognition based on images.

Each VR head-mounted display device in this embodiment may comprise a modeling device, a three-dimensional visual display device, a sound device, an interaction device, and the like. The VR head-mounted display device in this embodiment may be in communication connection with a terminal device. In practical applications, the terminal device may be any intelligent terminal with an Internet access function, such as a smartphone and a tablet. The terminal device may be connected to a router through a wireless local area network and access a server on a public network through the router.

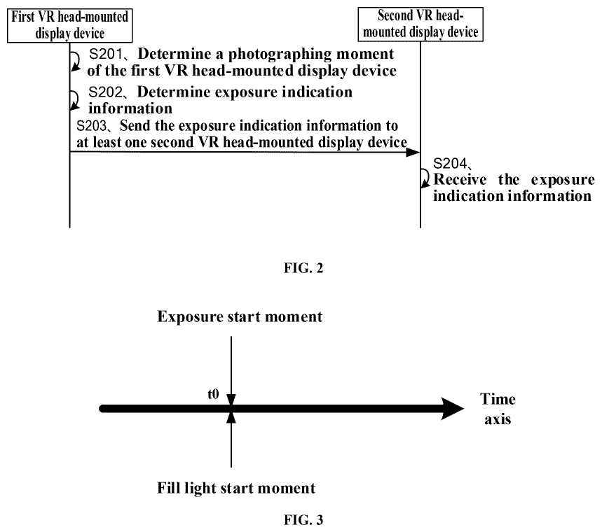

As shown in FIG. 2, FIG. 2 is a flowchart of a multi-device photographing control method according to an embodiment of the present disclosure. A first VR head-mounted display device is configured to establish a communication connection with at least one second VR head-mounted display device. The method comprises the following steps.

S201. A photographing moment of the first VR head-mounted display device is determined.

A camera and an infrared light filling lamp are arranged on a surface of a shell of the first VR head-mounted display device. The photographing moment is an exposure start moment of the camera and also a fill light start moment of the infrared light filling lamp. It can be understood that the photographing moment is a moment when a camera shutter is opened. Exposure starts when the camera shutter is opened. At the same time, the infrared light filling lamp starts to fill light. As shown in FIG. 3, FIG. 3 is a schematic diagram of a time axis of a photographing moment, where to represents the photographing moment, namely the exposure start moment and also the fill light start moment.

In some embodiments, the photographing moment of the first VR head-mounted display device is determined according to an input of a user. The input of the user comprises, but is not limited to, a button input, a voice input, and a gesture input. The button input is achieved by either a photographing button arranged on the first VR head-mounted display device or a button arranged on a handle. The handle establishes a communication connection with the first VR head-mounted display device. The voice input is achieved by a user wearing the first VR head-mounted display device through voice. For example, the user speaks “Take a photo” to the first VR head-mounted display device. The gesture input is generated in a case that a gesture of a user detected through a gesture recognition sensor arranged on the first VR head-mounted display device is matched with a preset gesture. The mode for determining the photographing moment of the first VR head-mounted display device in the above embodiment is only for illustrative purposes. The present disclosure does not limit this.

S202. Exposure indication information is determined according to the photographing moment of the first VR head-mounted display device.

The exposure indication information is used for determining a photographing moment of the at least one second VR head-mounted display device.

In the embodiments of the present disclosure, the exposure indication information may be the photographing moment of the first VR head-mounted display device. The exposure indication information may further comprise: a photographing moment or a delayed photographing time of the at least one second VR head-mounted display device. The exposure indication information comprises: device identifiers of various second VR head-mounted display devices among the at least one second VR head-mounted display device, and a photographing moment corresponding to each of the device identifiers. Or, the exposure indication information comprises: device identifiers of various second VR head-mounted display devices among the at least one second VR head-mounted display device, and a delayed photographing time corresponding to each of the device identifiers. Or, the exposure indication information comprises: the photographing moment of the first VR head-mounted display device, device identifiers of the various second VR head-mounted display devices among the at least one second VR head-mounted display device, and a delayed photographing time corresponding to each of the device identifiers.

The following will explain the processing process of the first VR head-mounted display device for the different contents comprised in the exposure indication information.

(1) The exposure indication information is the photographing moment of the first VR head-mounted display device.

In some embodiments, in the process of determining the exposure indication information, the first VR head-mounted display device first determines photographing sequence information of the at least one second VR head-mounted display device. The photographing sequence information corresponding to the at least one second VR head-mounted display device corresponds to a connection sequence, and the connection sequence is a sequence in which the at least one second VR head-mounted display device establishes the communication connection with the first VR head-mounted display device. In the embodiments of the present disclosure, the photographing sequence information of the at least one second VR head-mounted display device is determined according to a sequence in which the at least one second VR head-mounted display device establishes the communication connection with the first VR head-mounted display device.

Exemplarily, if the at least one second VR head-mounted display device comprise second VR head-mounted display device A, second VR head-mounted display device B, and second VR head-mounted display device C, and these second VR head-mounted display devices establish communication connections to the first VR head-mounted display device in a sequence of A, B, C, the photographing sequence information of the at least one second VR head-mounted display device is A, B, C. That is, the second VR head-mounted display device A takes a photo first, the second VR head-mounted display device B then takes a photo, and the second VR head-mounted display device C takes a photo last.

In some other embodiments, the photographing sequence information may be set by a user after the first VR head-mounted display device establishes the communication connection with the at least one VR head-mounted display device.

In some embodiments, after the first VR head-mounted display device determines the photographing sequence information of the at least one second VR head-mounted display device, the photographing moment of the first VR head-mounted display device is determined, and then the photographing moment is used as the exposure indication information. Exemplarily, if the first VR head-mounted display device determines the photographing moment as t0, the exposure indication information I is the photographing moment to of the first VR head-mounted display device.

It can be understood that the exposure indication information generated by the first VR head-mounted display device may only comprise the photographing moment of this device. After the exposure indication information is sent to each second VR head-mounted display device, each second VR head-mounted display device determines its own photographing moment according to its own connection sequence and a preset exposure time.

(2) The exposure indication information may comprise: the device identifiers of the various second VR head-mounted display devices among the at least one second VR head-mounted display device, and the photographing moment corresponding to each device identifier.

In some embodiments, after the photographing sequence information of the at least one second VR head-mounted display device is determined, photographing moments of the various second VR head-mounted display devices among the at least one second VR head-mounted display device are determined according to the photographing moment of the first VR head-mounted display device and the photographing sequence information of the at least one second VR head-mounted display device.

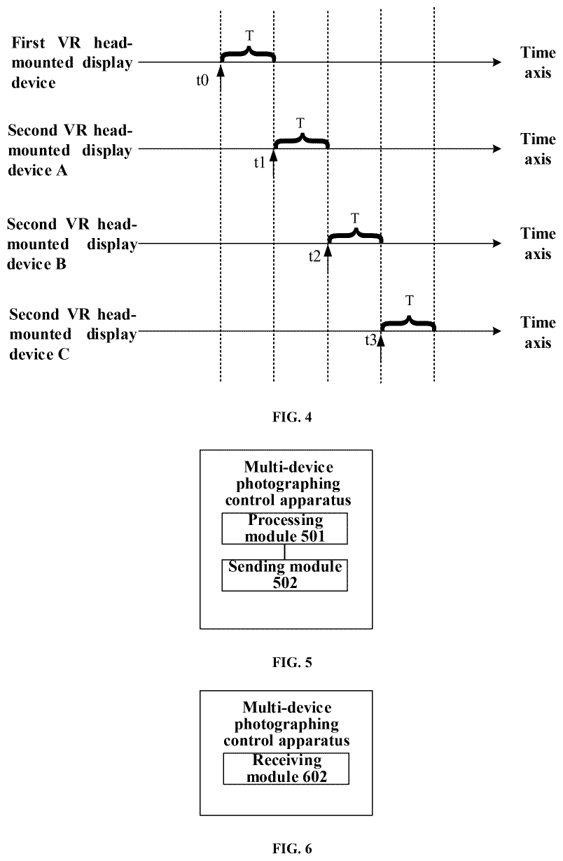

Examples are shown in FIG. 4. FIG. 4 is a schematic diagram of photographing moments of a first VR head-mounted display device and at least one second VR head-mounted display device. After the photographing moment of the first VR head-mounted display device is determined as to, if the photographing sequence information of second VR head-mounted display device A, second VR head-mounted display device B, and second VR head-mounted display device C among the at least one second VR head-mounted display device is determined as A, B, C, it can be determined, according to photographing moment to of the first VR head-mounted display device and the photographing sequence information of A, B, C, that the photographing moment of second VR head-mounted display device A is t1, the photographing moment of second VR head-mounted display device B is t2, and the photographing moment of second VR head-mounted display device C is t3, wherein t0<t1<t2<t3. Therefore, the exposure indication information II comprises: photographing moment t1 of second VR head-mounted display device A, photographing moment t2 of second VR head-mounted display device B, and photographing moment t3 of second VR head-mounted display device C.

A time interval between the photographing moments of the various second VR head-mounted display devices is greater than or equal to a preset exposure time. For example, the preset exposure time is T: the photographing moment of second VR head-mounted display device A is t1=t0+T: the photographing moment of second VR head-mounted display device B is t2=t0+2T; and the photographing moment of second VR head-mounted display device C is t3=t0+3T. In this case, the time interval between the photographing moments of the various second VR head-mounted display devices is equal to the preset exposure time T.

The first VR device obtains the device identifiers of the various second VR head-mounted display devices when establishing the communication connection with the at least one second VR device. The device identifiers comprise, but are not limited to, a device Identity Document (ID), a Media Access Control (MAC) address, and a user account. The present disclosure does not limit this.

In some embodiments, when establishing the communication connection with the at least one second VR head-mounted display device, the first VR head-mounted display device obtains and saves the device identifiers of the various second VR head-mounted display devices among the at least one second VR head-mounted display device. After the photographing moment of the first VR head-mounted display device is determined, the photographing moments of the various second VR head-mounted display devices among the at least one second VR head-mounted display device are determined, and the photographing moments are corresponded to the device identifiers.

Exemplarily, when establishing the communication connection with the at least one second VR head-mounted display device, the first VR head-mounted display device obtains and saves device identifier ID1 of second VR head-mounted display device A, device identifier ID2 of second VR head-mounted display device B, and device identifier ID3 of second VR head-mounted display device C. After photographing moment t0 of the first VR head-mounted display device is determined, photographing moment t1 of second VR head-mounted display device A, photographing moment t2 of second VR head-mounted display device B, and photographing moment t3 of second VR head-mounted display device C are determined, and the exposure indication information is generated in the first VR device. As shown in Table 1, Table 1 is the exposure indication information II.

TABLE 1

| Device identifier | Photographing moment |
|---|---|
| ID1 | t1 |
| ID2 | t2 |
| ID3 | t3 |

(3) The exposure indication information may comprise: the device identifiers of the various second VR head-mounted display devices among the at least one second VR head-mounted display device, and the delayed photographing time corresponding to each device identifier.

In some embodiments, after the photographing sequence information of the at least one second VR head-mounted display device is determined, the delayed photographing times of the various second VR head-mounted display devices among the at least one second VR head-mounted display device are determined according to the photographing moment of the first VR head-mounted display device and the photographing sequence information of the at least one second VR head-mounted display device.

Exemplarily, after the photographing moment of the first VR head-mounted display device is determined as to, if the photographing sequence information of second VR head-mounted display device A, second VR head-mounted display device B, and second VR head-mounted display device C among the at least one second VR head-mounted display device is determined as A, B, C, it can be determined, according to photographing moment t0 of the first VR head-mounted display device and the photographing sequence information of A, B, C, that the delayed photographing time of second VR head-mounted display device A is ΔT, the delayed photographing time of second VR head-mounted display device Bis 2ΔT, and the delayed photographing time of second VR head-mounted display device C is 3ΔT. Therefore, the exposure indication information III comprises: the delayed photographing time ΔT of second VR head-mounted display device A, the delayed photographing time 2ΔT of second VR head-mounted display device B, and the delayed photographing time 3ΔT of second VR head-mounted display device C. Thus after the exposure indication information III is sent to the at least one second VR head-mounted display device, the at least one second VR head-mounted display device determines their respective photographing moments according to the respective delayed photographing times from a moment at which the at least one second VR head-mounted display device receives the exposure indication information III.

As shown in Table 2, Table 2 is the exposure indication information III.

TABLE 2

| Device identifier | Delayed photographing time (unit: ms) |
|---|---|
| ID1 | ΔT |
| ID2 | ₂ΔT |
| ID3 | ₃ΔT |

In some embodiments, the delayed photographing time may be set by a user. For example, the user may set the delayed photographing time of second VR head-mounted display device A to be TA, the delayed photographing time of second VR head-mounted display device B to be TB, and the delayed photographing time of second VR head-mounted display device C to be TC. Therefore, the exposure indication information IV comprises: the delayed photographing time TA of second VR head-mounted display device A, the delayed photographing time TB of second VR head-mounted display device B, and the delayed photographing time TC of second VR head-mounted display device C. As shown in Table 3, Table 3 shows the exposure indication information IV.

TABLE 3

| Device identifier | Delayed photographing time (unit: ms) |
|---|---|
| ID1 | TA |
| ID2 | TB |
| ID3 | TC |

In addition, the first VR head-mounted display device and the at least one second VR head-mounted display device may preset a moment through the communication connection as an agreed moment. As such, after receiving the exposure indication information III or the exposure indication information IV, the at least one second VR head-mounted display device determines its own photographing moment according to the agreed moment and the respective delayed photographing time.

(4) The exposure indication information may comprise: the photographing moment of the first VR head-mounted display device, the device identifiers of the various second VR head-mounted display devices among the at least one second VR head-mounted display device, and the delayed photographing time corresponding to each device identifier.

In some embodiments, after the photographing sequence information of the at least one second VR head-mounted display device is determined, the delayed photographing times of the various second VR head-mounted display devices among the at least one second VR head-mounted display device are determined according to the photographing moment of the first VR head-mounted display device and the photographing sequence information of the at least one second VR head-mounted display device.

Exemplarily, after the photographing moment of the first VR head-mounted display device is determined as to, if the photographing sequence information of second VR head-mounted display device A, second VR head-mounted display device B, and second VR head-mounted display device C among the at least one second VR head-mounted display device is determined as A, B, C, it can be determined, according to photographing moment to of the first VR head-mounted display device and the photographing sequence information of A, B, C, that the delayed photographing time of second VR head-mounted display device A is ΔT, the delayed photographing time of second VR head-mounted display device B is 2ΔT, and the delayed photographing time of second VR head-mounted display device C is 3 ΔT. Therefore, the exposure indication information V comprises: photographing moment t0 of the first VR head-mounted display device, delayed photographing time ΔT of second VR head-mounted display device A, delayed photographing time 2ΔT of second VR head-mounted display device B, and delayed photographing time 3ΔT of second VR head-mounted display device C. As such, after the exposure indication information V is sent to the at least one second VR head-mounted display device, the at least one second VR head-mounted display device determines their respective photographing moments according to photographing moment to of the first VR head-mounted display device and the delayed photographing times of the at least one second VR head-mounted display device.

As shown in Table 4, Table 4 is the exposure indication information V.

TABLE 4

| | Delayed photographing |
|---|---|
| | time/photographing moment |
| Device identifier | t0 |
| ID1 | ΔT |
| ID2 | ₂ΔT |
| ID3 | ₃ΔT |

Photographing moment to in Table 4 above means the photographing moment of the first VR head-mounted display device. After receiving the exposure indication information, the at least one second VR head-mounted display device can determine their respective photographing moments according to photographing moment to and the respective delayed photographing times.

S203. The exposure indication information is sent to the at least one second VR head-mounted display device.

The process of sending the exposure indication information to the at least one second VR head-mounted display device according to different exposure indication information mentioned above will be explained below.

A. In a case that the exposure indication information is the photographing moment of the first VR head-mounted display device.

In some embodiments, in a case that the exposure indication information is the photographing moment of the first VR head-mounted display device, the first VR head-mounted display device sends the exposure indication information to the at least one second VR head-mounted display device by broadcasting the photographing moment of the first VR head-mounted display device.

The first VR head-mounted display device first determines photographing sequence information of the at least one second VR head-mounted display device. The photographing sequence information corresponding to the at least one second VR head-mounted display device corresponds to a connection sequence, and the connection sequence is a sequence in which the at least one second VR head-mounted display device establishes the communication connection with the first VR head-mounted display device. In the embodiments of the present disclosure, the photographing sequence information of the at least one second VR head-mounted display device is determined according to a sequence in which the at least one second VR head-mounted display device establishes the communication connection with the first VR head-mounted display device.

When establishing the communication connection with the at least one second VR head-mounted display device, the first VR head-mounted display device sends the photographing sequence information to the at least one second VR head-mounted display device, and then the first VR head-mounted display device broadcasts the photographing moment of the first VR head-mounted display device to send the exposure indication information to the at least one second VR head-mounted display device.

Exemplarily, when establishing the communication connection with the at least one second VR head-mounted display device, the first VR head-mounted display device sends the photographing sequence information of A, B, C to second VR head-mounted display device A, second VR head-mounted display device B, and second VR head-mounted display device C. Then, the exposure indication information I is the photographing moment to of the first VR head-mounted display device, such that second VR head-mounted display device A, second VR head-mounted display device B, and second VR head-mounted display device C determine their respective photographing moments according to the photographing sequence information and photographing moment to.

B. In a case that the exposure indication information comprises the device identifiers of the various second VR head-mounted display devices among the at least one second VR head-mounted display device, and the photographing moment corresponding to each device identifier.

In some embodiments, in a case that the exposure indication information comprises the device identifiers of the various second VR head-mounted display devices among the at least one second VR head-mounted display device, and the photographing moment corresponding to each device identifier, the first VR head-mounted display device sends the photographing moments of the at least one second VR head-mounted display device to the at least one second VR head-mounted display device by broadcasting, such that the at least one second VR head-mounted display device determines the respective photographing moment according to the respective device identifier.

Exemplarily, the exposure indication information II is as shown in Table 1 above. The first VR head-mounted display device will send the exposure indication information II to the at least one second VR head-mounted display device by broadcasting, such that the at least one second VR head-mounted display device determines the respective photographing moments according to the device identifiers of the various second VR head-mounted display devices comprised in the exposure indication information II.

In some other embodiments, in a case that the exposure indication information comprises the device identifiers of the various second VR head-mounted display devices among the at least one second VR head-mounted display device, and the photographing moment corresponding to each device identifier, the first VR head-mounted display device sends the respective photographing moments of the various second VR head-mounted display devices respectively to the at least one second VR head-mounted display device according to the device identifiers of the various second VR head-mounted display devices among the at least one second VR head-mounted display device.

Exemplarily, the exposure indication information II is as shown in Table 1 above. The first VR head-mounted display device will send photographing moment t1 of second VR head-mounted display device A to second VR head-mounted display device A according to device identifier ID1 of second VR head-mounted display device A, send photographing moment t2 of second VR head-mounted display device B to second VR head-mounted display device B according to device identifier ID2 of second VR head-mounted display device B, and send photographing moment t3 of second VR head-mounted display device C to second VR head-mounted display device C according to device identifier ID3 of second VR head-mounted display device C.

C. In a case that the exposure indication information comprises the device identifiers of the various second VR head-mounted display devices among the at least one second VR head-mounted display device, and the delayed photographing time corresponding to each device identifier.

In some embodiments, in a case that the exposure indication information comprises the device identifiers of the various second VR head-mounted display devices among the at least one second VR head-mounted display device, and the delayed photographing time corresponding to each device identifier, the first VR head-mounted display device sends the delayed photographing time of the at least one second VR head-mounted display device to the at least one second VR head-mounted display device by broadcasting, such that the at least one second VR head-mounted display device determines the respective photographing moment according to the respective device identifier and the respective delayed photographing time.

Exemplarily, the exposure indication information III is as shown in Table 2 above. The first VR head-mounted display device will send the exposure indication information III to the at least one second VR head-mounted display device, including second VR head-mounted display device A, second VR head-mounted display device B, and second VR head-mounted display device C, by broadcasting, such that the at least one second VR head-mounted display device determines the respective photographing moments according to the device identifiers, comprised in the exposure indication information III, of the various second VR head-mounted display devices.

In some other embodiments, in a case that the exposure indication information comprises the device identifiers of the various second VR head-mounted display devices among the at least one second VR head-mounted display device, and the delayed photographing time corresponding to each device identifier, the first VR head-mounted display device sends the respective delayed photographing time of the various second VR head-mounted display devices respectively to the at least one second VR head-mounted display device according to the device identifiers of the various second VR head-mounted display devices among the at least one second VR head-mounted display device.

Exemplarily, the exposure indication information IV is as shown in Table 3 above. The first VR head-mounted display device will send delayed photographing time TA of second VR head-mounted display device A to second VR head-mounted display device A according to device identifier ID1 of second VR head-mounted display device A, send delayed photographing time TB of second VR head-mounted display device B to second VR head-mounted display device B according to device identifier ID2 of second VR head-mounted display device B, and send delayed photographing time TC of second VR head-mounted display device C to second VR head-mounted display device C according to device identifier ID3 of second VR head-mounted display device C.

D. In a case that the exposure indication information comprises: the photographing moment of the first VR head-mounted display device, the device identifiers of the various second VR head-mounted display devices among the at least one second VR head-mounted display device, and the delayed photographing time corresponding to each device identifier.

In some embodiments, the first VR head-mounted display device sends the photographing moment of the first VR head-mounted display device and the delayed photographing times of the at least one second VR head-mounted display device to the at least one second VR head-mounted display device by broadcasting, such that the at least one second VR head-mounted display device determines the respective photographing moment according to the photographing moment of the first VR head-mounted display device, the respective device identifier, and the respective delayed photographing time.

Exemplarily, the exposure indication information V is as shown in Table 4 above. The first VR head-mounted display device will send the exposure indication information V to the at least one second VR head-mounted display device, including second VR head-mounted display device A, second VR head-mounted display device B, and second VR head-mounted display device C, by broadcasting, such that the at least one second VR head-mounted display device determines the respective photographing moment according to the device identifiers of the various second VR head-mounted display devices and photographing moment to of the first VR head-mounted display device comprised in the exposure indication information V.

In some other embodiments, the first VR head-mounted display device sends the respective delayed photographing times of the various second VR head-mounted display device and the photographing moment of the first VR head-mounted display device respectively to the at least one second VR head-mounted display device according to the device identifiers of the various second VR head-mounted display devices among the at least one second VR head-mounted display device, such that the at least one second VR head-mounted display device determines the respective photographing moments according to the photographing moment of the first VR head-mounted display device and the respective delayed photographing times.

Exemplarily, the exposure indication information V is as shown in Table 4 above. The first VR head-mounted display device will send delayed photographing time ΔT of second VR head-mounted display device A and photographing moment to of the first VR head-mounted display device to second VR head-mounted display device A according to device identifier ID1 of second VR head-mounted display device A, send delayed photographing time 2ΔT of second VR head-mounted display device B and photographing moment t0 of the first VR head-mounted display device to second VR head-mounted display device B according to device identifier ID2 of second VR head-mounted display device B, and send delayed photographing time 3ΔT of second VR head-mounted display device C and photographing moment to of the first VR head-mounted display device to second VR head-mounted display device C according to device identifier ID3 of second VR head-mounted display device C.

In the above embodiments, depending on the different contents comprised in the exposure indication information, the exposure indication information is sent to the at least one second VR head-mounted display device respectively or by broadcasting, such that the at least one second VR head-mounted display device can accurately receive the exposure indication information in a timely manner.

S204. Exposure indication information sent by the first VR head-mounted display device is received.

The exposure indication information is used for determining a photographing moment of a second VR head-mounted display device. The photographing moment is an exposure start moment of the camera and also a fill light start moment of the infrared light filling lamp.

After the exposure indication information sent by the first VR head-mounted display device is received, the photographing moment of the second VR head-mounted display device is determined. The process of determining the photographing moment of each second VR head-mounted display device according to the different exposure indication information mentioned above will be explained below.

a. In a case that the exposure indication information is a photographing moment of the first VR head-mounted display device.

In some embodiments, during establishment of a communication connection with the first VR head-mounted display device, photographing sequence information sent by the first VR head-mounted display device and corresponding to at least one second VR head-mounted display device is received. Then, the photographing moment of the first VR head-mounted display device broadcast by the first VR head-mounted display device is received. Further, the photographing moment of the second VR head-mounted display device is determined according to the photographing sequence information of the second VR head-mounted display device.

Exemplarily, during establishment of the communication connection with the first VR head-mounted display device, the photographing sequence information received by the at least one second VR head-mounted display device A, B, and C is A, B, C. Then second VR head-mounted display device A receives the exposure indication information I. The exposure indication information I is photographing moment to of the first VR head-mounted display device. The photographing moment of second VR head-mounted display device A is determined as t1 according to the photographing sequence information and photographing moment to, where t1=t0+T, and T is a preset exposure time.

b. In a case that the exposure indication information comprises the device identifiers of the various second VR head-mounted display devices among the at least one second VR head-mounted display device, and the photographing moment corresponding to each device identifier.

In some embodiments, the exposure indication information comprises the device identifiers of the various second VR head-mounted display devices among the at least one second VR head-mounted display device, and the photographing moment corresponding to each device identifier. The exposure indication information is as shown in Table 1. In this case, each second VR head-mounted display device determines, from the exposure indication information and according to its own device identifier, a target device identifier corresponding to the respective second VR head-mounted display device. The photographing moment corresponding to the target device identifier is determined as the photographing moment of the respective second VR head-mounted display device.

Exemplarily, after the exposure indication information II sent by the first VR head-mounted display device is received, if the device identifier of second VR head-mounted display device A is ID1, the second VR head-mounted display device A determines that the target device identifier in the exposure indication information is ID1, and determines that the photographing moment of second VR head-mounted display device A is t1 according to target device identifier ID1. Subsequently, the camera is used to start exposure at photographing moment t1, and at the same time, the infrared light filling lamp is used to start light filling. As such, in a case that a plurality of VR head-mounted display devices simultaneously work, the respective light filling times are staggered to avoid overexposure of an image photographed by each VR head-mounted display device. This improves the quality of the images.

c. In a case that the exposure indication information comprises: the device identifiers of the various second VR head-mounted display devices among the at least one second VR head-mounted display device, and the delayed photographing time corresponding to each device identifier.

In some embodiments, the exposure indication information comprises the device identifiers of the various second VR head-mounted display devices among the at least one second VR head-mounted display device, and the delayed photographing time corresponding to each device identifier. The exposure indication information is as shown in Table 2 or Table 3. In this case, each second VR head-mounted display device determines, from the exposure indication information and according to the device identifier of the respective second VR head-mounted display device, a target device identifier corresponding to the respective second VR head-mounted display device, and determines the photographing moment of the respective second VR head-mounted display device according to the delayed photographing time corresponding to the target device identifier, from a moment at which the exposure indication information is received. Or, the photographing moment of the second VR head-mounted display device is determined according to an agreed moment predetermined by the first VR head-mounted display device and the second VR head-mounted display device through the communication connection in combination with the delayed photographing time corresponding to the target device identifier.

Exemplarily, after the exposure indication information IV sent by the first VR head-mounted display device is received, if the device identifier of second VR head-mounted display device A is ID1, the second VR head-mounted display device A determines that the target device identifier in the exposure indication information is ID1, and determines that the delayed photographing time of second VR head-mounted display device A is TA according to target device identifier ID1. Further, second VR head-mounted display device A may use the camera to start exposure after waiting for TA ms from the moment at which the exposure indication information is received, and at the same time, use the infrared light filling lamp to start light filling. As such, in a case that a plurality of VR head-mounted display devices simultaneously work, the respective light filling times are staggered to avoid overexposure of an image photographed by each VR head-mounted display device. This improves the quality of the images.

d. In a case that the exposure indication information comprises: the photographing moment of the first VR head-mounted display device, the device identifiers of the various second VR head-mounted display devices among the at least one second VR head-mounted display device, and the delayed photographing time corresponding to each device identifier.

In some embodiments, each second VR head-mounted display device determines, from the exposure indication information and according to the device identifier of the respective second VR head-mounted display device, a target device identifier corresponding to the second VR head-mounted display device, further determines the delayed photographing time corresponding to the target device identifier, and then determines the photographing moment of the respective second VR head-mounted display device according to the delayed photographing time from the photographing moment of the first delayed photographing time.

Exemplarily, as shown in Table 4, after the exposure indication information V sent by the first VR head-mounted display device is received, if the device identifier of second VR head-mounted display device A is ID1, the second VR head-mounted display device A determines that the target device identifier in the exposure indication information Vis ID1, and determines that the delayed photographing time of second VR head-mounted display device A is TA according to target device identifier ID1. Further, photographing moment of the first VR head-mounted display device comprised in the exposure indication information V is obtained. TA ms is used for waiting from photographing moment to of the first VR head-mounted display device, thus the exposure start time of the camera is t0+TA ms, and at this time, the infrared light filling lamp is used to start light filling.

In summary, the present disclosure provides a multi-device photographing control method. A first VR head-mounted display device is configured to establish a communication connection with at least one second VR head-mounted device. In this method, a photographing moment of the first VR head-mounted display device is determined first. The photographing moment of the first VR head-mounted display device is both an exposure start moment of a camera of the first VR head-mounted display device and a fill light start moment of an infrared light filling lamp of the first VR head-mounted display device. Exposure indication information is determined according to the photographing moment of the first VR head-mounted display device, and the exposure indication information is sent to at least one second VR head-mounted display device to instruct the at least one second VR head-mounted display device to determine photographing moments of various second VR head-mounted display devices. As such, the first VR head-mounted display device controls the exposure moment of at least one VR head-mounted display device to achieve light filling and exposure for a plurality of VR head-mounted display devices at different moments in the same scene and prevent overexposure of an image photographed by each VR head-mounted display device.

As shown in FIG. 5, FIG. 5 is a structural diagram I of the first VR head-mounted display device according to an embodiment of the present disclosure. The first VR head-mounted display device comprises:
a processing module 501, configured to: determine a photographing moment of the first VR head-mounted display device, and determine exposure indication information according to the photographing moment of the first VR head-mounted display device; and
a sending module 502, configured to send the exposure indication information to the at least one second VR head-mounted display device.

The exposure indication information is used for determining a photographing moment of the at least one second VR head-mounted display device.

As an optional implementation of the embodiments of the present disclosure, the exposure indication information comprises: the photographing moment or a delayed photographing time of the at least one second VR head-mounted display device; and
the sending module 502 is specifically configured to respectively send photographing moments or delayed photographing times of various second VR head-mounted display devices to the at least one second VR head-mounted display device.

A time interval between the photographing moments of various second VR head-mounted display devices among the at least one second VR head-mounted display device is greater than or equal to preset exposure time, and a time difference between the delayed photographing times of the various second VR head-mounted display devices is greater than or equal to the preset exposure time.

As an optional implementation of the embodiments of the present disclosure, the processing module 501 is specifically configured to: determine photographing sequence information of the at least one second VR head-mounted display device; and
determine the photographing moments or delayed photographing times of the various second VR head-mounted display devices among the at least one second VR head-mounted display device according to the photographing moment of the first VR head-mounted display device and the photographing sequence information of the at least one second VR head-mounted display device.

As an optional implementation of the embodiments of the present disclosure, the processing module 501 is specifically configured to determine the photographing sequence information of the at least one second VR head-mounted display device according to a sequence in which the at least one second VR head-mounted display device establishes the communication connection with the first VR head-mounted display device.

As an optional implementation of the embodiments of the present disclosure, the processing module 501 is further configured to: when the first VR head-mounted display device establishes the communication connection with the at least one second VR head-mounted display device, send photographing sequence information to the at least one second VR head-mounted display device, wherein the photographing sequence information corresponding to the at least one second VR head-mounted display device corresponds to a connection sequence, and the connection sequence is a sequence in which the at least one second VR head-mounted display device establishes the communication connection with the first VR head-mounted display device.

As an optional implementation of the embodiments of the present disclosure, the exposure indication information is the photographing moment of the first VR head-mounted display device.

As an optional implementation of the embodiments of the present disclosure, the exposure indication information comprises: device identifiers of various second VR head-mounted display devices among the at least one second VR head-mounted display device, and a photographing moment or a delayed photographing time corresponding to each of the device identifiers.

As an optional implementation of the embodiments of the present disclosure, the sending module 502 is specifically configured to: send the exposure indication information to the at least one second VR head-mounted display device by broadcasting: or, respectively send the exposure indication information to the at least one second VR head-mounted display device.

As shown in FIG. 6, FIG. 6 is a structural diagram I of the second VR head-mounted display device according to an embodiment of the present disclosure. The embodiments of the present disclosure provide a second VR head-mounted device. The VR head-mounted device comprises:
a receiving module 601, configured to receive exposure indication information sent by the first VR head-mounted display device,
wherein the exposure indication information is used for determining a photographing moment of the second VR head-mounted display device.

As an optional implementation of the embodiments of the present disclosure, the exposure indication information comprises a photographing moment or a delayed photographing time of the second VR head-mounted display device.

As an optional implementation of the embodiments of the present disclosure, the receiving module 601 is specifically configured to: receive a photographing moment of the first VR head-mounted display device broadcast by the first VR head-mounted display device; and determine the photographing moment of the second VR head-mounted display device according to the photographing moment of the first VR head-mounted display device and the photographing sequence information of the second VR head-mounted display device.

As an optional implementation of the embodiments of the present disclosure, the exposure indication information comprises: device identifiers of various second VR head-mounted display devices among the at least one second VR head-mounted display device, and a photographing moment corresponding to each device identifier; and the receiving module 601 is specifically configured to: receive at least one device identifier broadcast by the first VR head-mounted display device, and the photographing moment corresponding to each device identifier:
determine a target device identifier corresponding to the second VR head-mounted display device; and
determine the photographing moment corresponding to the target device identifier as the photographing moment of the second VR head-mounted display device.

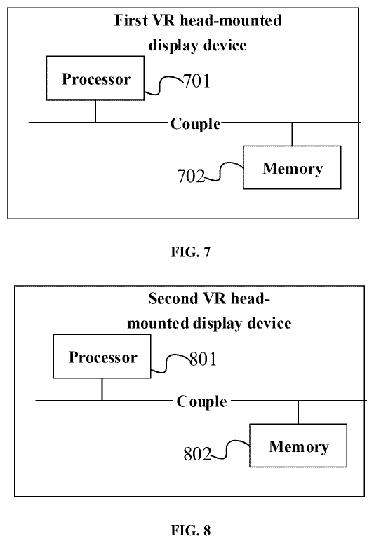

As shown in FIG. 7, the embodiments of the present disclosure provide a first VR head-mounted display device. The first VR head-mounted display device comprises: a processor, a memory, and a computer program stored on the memory and runnable on the processor. The computer program, when run by the processor, implements the various processes, performed by the first VR head-mounted display device, in the multi-device photographing control method in the above method embodiments, and can achieve the same technical effects. To avoid repetitions, detailed descriptions will be omitted.

As shown in FIG. 8, the embodiments of the present disclosure provide a second VR head-mounted display device. The second VR head-mounted display device comprises: a processor, a memory, and a computer program stored on the memory and runnable on the processor. The computer program, when run by the processor, implements the various processes, performed by the second VR head-mounted display device, in the multi-device photographing control method in the above method embodiments, and can achieve the same technical effects. To avoid repetitions, detailed descriptions will be omitted.

The embodiments of the present invention further provide a computer-readable storage medium, with a computer program stored thereon. The computer program, when run by a processor, implements the various processes, performed by the first VR head-mounted display device, in the multi-device photographing control method in the above method embodiments, or implements the various processes, performed by the second VR head-mounted display device, in the multi-device photographing control method in the above method embodiments, and can achieve the same technical effects. To avoid repetitions, detailed descriptions will be omitted.

The computer-readable storage medium may be a Read-Only Memory (ROM), a random access memory (RAM), a magnetic disk, or a CD.

The embodiments of the present invention provide a computer program product, with a computer program stored thereon. The computer program, when run by a processor, implements the various processes, performed by the first VR head-mounted display device, in the multi-device photographing control method in the above method embodiments, or implements the various processes, performed by the second VR head-mounted display device, in the multi-device photographing control method in the above method embodiments, and can achieve the same technical effects. To avoid repetitions, detailed descriptions will be omitted.

Those skilled in the art should understand that the embodiments of the present disclosure may be methods, systems or computer program products. Therefore, the present disclosure may adopt the form of a complete hardware embodiment, a complete software embodiment, or a software and hardware combination embodiment. In addition, the present disclosure may use the form of a computer program product implemented on one or multiple computer-sensitive storage media including computer-sensitive program codes.

In the present disclosure, the processor may be a Central Processing Unit (CPU), or may be a second general-purpose processor, a Digital Signal Processor (DSP), an Application Specific Integrated Circuit (ASIC), a Field-Programmable Gate Array (FPGA) or a second programmable logic device, a discrete gate or transistor logic device, a discrete hardware component, and the like. The general-purpose processor may be a microprocessor, or the processor may be any conventional processor, or the like.

In the present disclosure, the memory may comprise a volatile memory in a computer readable medium, a RAM and/or a non-volatile memory, etc., such as an ROM or a flash RAM. The memory is an example of the computer-readable medium.

In the present disclosure, the computer-readable medium comprises a non-volatile storage medium, a volatile storage medium, a movable storage medium, and an unmovable storage medium. The storage medium can achieve information storage by any method or technology. The information can be computer-readable instructions, data structures, program modules, or second data. Examples of the computer storage media comprise, but are not limited to, a Phase-change Random Access Memory (PRAM), a Static Random Access Memory (SRAM), a Dynamic Random Access Memory (DRAM), a second type of RAMs, an ROM, an Electrically Erasable Programmable Read-Only Memory (EEPROM), a flash memory or other internal memory technologies, a CD-ROM, a Digital Video Disk (DVD) or a second optical memory, a magnetic cartridge type magnetic tape, a magnetic tape/disk storage device or a second magnetic storage device or any second non-transmitting medium, and may be used for storing information that may be accessed by a computing device. The computer readable medium does not comprise transitory computer readable media, such as modulated data signals and carriers, according to definitions herein.

It should be noted that in this document, relationship terms such as “first” and “second” are used solely to distinguish one entity or operation from another entity or operation without necessarily requiring or implying any actual such relationship or order between such entities or operations. Furthermore, the terms “comprise”, “including”, or any second variation thereof, are intended to encompass a non-exclusive inclusion, such that a process, method, article, or device that comprises a list of elements does not comprise only those elements but may comprise second elements not explicitly listed or inherent to such process, method, article, or device. Without more constraints, an element limited by “comprises a . . . ” does not preclude the existence of additional identical elements in the process, method, product, or device that comprises the element.

The above only describes the specific implementations of the present disclosure, which enables those skilled in the art to understand or implement the present disclosure. The various modifications to these embodiments will be apparent to those skilled in the art, and the general principles defined herein can be implemented in other embodiments without departing from the spirit or scope of the present disclosure. Thus, the present disclosure is not limited to these embodiments shown herein, but accords with the broadest scope consistent with the principles and novel features disclosed herein.

1. A multi-device photographing control method, applied to a first virtual reality (VR) head-mounted display device, wherein the first VR head-mounted display device is configured to establish a communication connection with at least one second VR head-mounted device, and the method comprises:
determining a photographing moment of the first VR head-mounted display device;
determining exposure indication information according to the photographing moment of the first VR head-mounted display device; and
sending the exposure indication information to the at least one second VR head-mounted display device,
wherein the exposure indication information is used for determining a photographing moment of the at least one second VR head-mounted display device.

2. The method according to claim 1, wherein the exposure indication information comprises: the photographing moment or a delayed photographing time of the at least one second VR head-mounted display device.

3. The method according to claim 2, wherein determining the exposure indication information according to the photographing moment of the first VR head-mounted display device comprises:
determining photographing sequence information of the at least one second VR head-mounted display device; and
determining the photographing moment or the delayed photographing time of the at least one second VR head-mounted display device according to the photographing moment of the first VR head-mounted display device and the photographing sequence information of the at least one second VR head-mounted display device.

4. The method according to claim 2, wherein a time interval between the photographing moments of various second VR head-mounted display devices among the at least one second VR head-mounted display device is greater than or equal to a preset exposure time, and a time difference between delayed photographing times of the various second VR head-mounted display devices is greater than or equal to the preset exposure time.

5. The method according to claim 3, wherein determining the photographing sequence information of the at least one second VR head-mounted display device comprises:
determining the photographing sequence information of the at least one second VR head-mounted display device according to a sequence in which the at least one second VR head-mounted display device establishes the communication connection with the first VR head-mounted display device.

6. The method according to claim 2, wherein the exposure indication information comprises: device identifiers of various second VR head-mounted display devices among the at least one second VR head-mounted display device, and a photographing moment or a delayed photographing time corresponding to each of the device identifiers.

7. The method according to claim 1, wherein the exposure indication information is the photographing moment of the first VR head-mounted display device.

8. The method according to claim 7, wherein the method further comprises:
when the first VR head-mounted display device establishes the communication connection with the at least one second VR head-mounted display device, sending photographing sequence information to the at least one second VR head-mounted display device, wherein the photographing sequence information corresponding to the at least one second VR head-mounted display device corresponds to a connection sequence, and the connection sequence is a sequence in which the at least one second VR head-mounted display device establishes the communication connection with the first VR head-mounted display device.

9. The method according to claim 1, wherein sending the exposure indication information to the at least one second VR head-mounted display device comprises:
sending the exposure indication information to the at least one second VR head-mounted display device by broadcasting; or
sending the exposure indication information to the at least one second VR head-mounted display device respectively.

10. A multi-device photographing control method, applied to a second VR head-mounted display device, wherein the second VR head-mounted display device is configured to establish a communication connection with a first VR head-mounted device, and the method comprises:
receiving exposure indication information sent by the first VR head-mounted display device,
wherein the exposure indication information is used for determining a photographing moment of the second VR head-mounted display device.

11. The method according to claim 10, wherein the exposure indication information comprises a photographing moment or a delayed photographing time of the second VR head-mounted display device.

12. The method according to claim 10, wherein the method further comprises:
when establishing the communication connection with the first VR head-mounted display device, receiving photographing sequence information sent by the first VR head-mounted display device;
wherein receiving the exposure indication information sent by the first VR head-mounted display device comprises:
receiving a photographing moment of the first VR head-mounted display device broadcast by the first VR head-mounted display device; and
wherein the method further comprises:
determining the photographing moment of the second VR head-mounted display device according to the photographing moment of the first VR head-mounted display device and the photographing sequence information of the second VR head-mounted display device.

13. The method according to claim 11, wherein the exposure indication information comprises: a device identifier of at least one second VR head-mounted display device, and a photographing moment or a delayed photographing time corresponding to each device identifier; and
wherein receiving the exposure indication information sent by the first VR head-mounted display device comprises:
receiving at least one device identifier broadcast by the first VR head-mounted display device, and a photographing moment or a delayed photographing time corresponding to each device identifier;
determining a target device identifier corresponding to the second VR head-mounted display device; and
determining the photographing moment or the delayed photographing time corresponding to the target device identifier as the photographing moment or the delayed photographing time of the second VR head-mounted display device.

14. (canceled)

15. (canceled)

16. A first VR head-mounted display device,
comprising a processor, a memory, and a computer program stored on the memory and executable on the processor, wherein the computer program, when run by the processor, causes the processor to:
determine a photographing moment of the first VR head-mounted display device;
determine exposure indication information according to the photographing moment of the first VR head-mounted display device; and
send the exposure indication information to the at least one second VR head-mounted display device,
wherein the exposure indication information is used for determining a photographing moment of the at least one second VR head-mounted display device.

17. (canceled)

18. (canceled)

19. (canceled)

20. The first VR head-mounted display device according to claim 16, wherein the exposure indication information comprises: the photographing moment or a delayed photographing time of the at least one second VR head-mounted display device.

21. The first VR head-mounted display device according to claim 20, wherein the processor being caused to determine the exposure indication information according to the photographing moment of the first VR head-mounted display device comprises being caused to:
determine photographing sequence information of the at least one second VR head-mounted display device; and
determine the photographing moment or the delayed photographing time of the at least one second VR head-mounted display device according to the photographing moment of the first VR head-mounted display device and the photographing sequence information of the at least one second VR head-mounted display device.

22. The first VR head-mounted display device according to claim 20, wherein a time interval between the photographing moments of various second VR head-mounted display devices among the at least one second VR head-mounted display device is greater than or equal to a preset exposure time, and a time difference between delayed photographing times of the various second VR head-mounted display devices is greater than or equal to the preset exposure time.

23. The first VR head-mounted display device according to claim 21, wherein the processor being caused to determine the photographing sequence information of the at least one second VR head-mounted display device comprises being caused to:
determine the photographing sequence information of the at least one second VR head-mounted display device according to a sequence in which the at least one second VR head-mounted display device establishes the communication connection with the first VR head-mounted display device.

24. The first VR head-mounted display device according to claim 20, wherein the exposure indication information comprises: device identifiers of various second VR head-mounted display devices among the at least one second VR head-mounted display device, and a photographing moment or a delayed photographing time corresponding to each of the device identifiers.

25. The first VR head-mounted display device according to claim 16, wherein the exposure indication information is the photographing moment of the first VR head-mounted display device.
